(19) United States
(12) Patent Application Publication
(10) Pub. No.: US 2026/0302080 A1
(43) Pub. Date: Oct. 1, 2026

(54) MULTILAYER ELECTRONIC COMPONENT

(71) Applicant: SAMSUNG ELECTRO-MECHANICS CO., LTD., Suwon-si (KR)

(72) Inventors: Seung Min Kang, Suwon-si (KR); Sung Hyung Kang, Suwon-si (KR)

(73) Assignee: SAMSUNG ELECTRO-MECHANICS CO., LTD., Suwon-si (KR)

(21) Appl. No.: 19/563,623

(22) Filed: Mar. 11, 2026

(30) Foreign Application Priority Data
Mar. 27, 2025 (KR) 10-2025-0039506

(51) Int. Cl. H01G 4/30

(52) U.S. Cl. CPC H01G 4/30

(57) ABSTRACT

A multilayer electronic component includes a body having a capacitance forming portion in which a dielectric layer and internal electrodes overlap in a first direction, cover portions disposed on opposite surfaces of the capacitance forming portion in the first direction, and side margin portions disposed on opposite surfaces of the capacitance forming portion in a third direction perpendicular to the first direction. External electrodes are disposed on opposite surfaces of the body in a second direction and are electrically connected to the internal electrodes. When an average thickness of the cover portions in the first direction is Tc and an average width of the side margin portions in the third direction is Wm, Wm is 18 μm or more and less than 200 μm, and Wm/Tc is 0.86 or more and 1.71 or less.

### CROSS-REFERENCE TO RELATED APPLICATION(S)

This application claims the benefit of priority to Korean Patent Application No. 10-2025-0039506 filed on Mar. 27, 2025 in the Korean Intellectual Property Office, the disclosure of which is incorporated herein by reference in its entirety.

### TECHNICAL FIELD

The present disclosure relates to a multilayer electronic component.

Multilayer ceramic capacitors (MLCCs), a type of multilayer electronic component, are chip-shaped capacitors mounted on the printed circuit boards of various types of electronic products, for example, video devices such as Liquid Crystal Displays (LCD) and Plasma Display Panels (PDP), computers, smartphones, and mobile phones, as well as onboard charger (OBC) DC-DC converters for electric vehicles, to charge or discharge electricity therein or therefrom.

With the recent advancements in smartphones, wearable devices, 5G communication modules, electric vehicles (EVs), and the like, the need for thinner and more compact internal components is increasing. Consequently, the development of low-profile ceramic capacitors (LPCCs) that maintain the performance of existing MLCCs while reducing their thickness is essential.

Meanwhile, LPCCs have an asymmetrical shape compared to existing MLCCs, and may thus be vulnerable to chipping, cracking, and reduced moisture resistance.

Furthermore, as the thickness of LPCC decreases, the proportion of the corner area that is relatively prone to chipping increases, potentially exacerbating chipping defects, cracking defects, and reduced moisture-resistant reliability.

Furthermore, if a margin-less design is applied that exposes the internal electrode in the width direction of the body to maximize the width direction area of the internal electrode, and a separate side margin portion is attached to the width-direction exposed internal electrode surface before firing after unit chip fabrication, the corner of the side margin portion may become more vulnerable.

### SUMMARY

An aspect of the present disclosure is to alleviate a phenomenon of chipping defects occurring at corners of a side margin portion.

An aspect of the present disclosure is to resolve the problem of corners of a side margin portion becoming a major path for external moisture infiltration and thus reducing moisture resistance reliability of multilayer electronic components.

An aspect of the present disclosure is to alleviate increased vulnerability of a side margin portion in low-profile ceramic capacitors.

According to an aspect of the present disclosure, a multilayer electronic component includes a body including a capacitance forming portion in which a dielectric layer and an internal electrode overlap in a first direction; and an external electrode disposed on both surfaces of the body opposing each other in a second direction, perpendicular to the first direction, and connected to the internal electrode. The body includes a cover portion disposed on both surfaces of the capacitance forming portion, opposing each other in the first direction, and a side margin portion disposed on both surfaces of the capacitance forming portion, opposing each other in a third direction, perpendicular to the first and second directions. When an average thickness of the cover portion in the first direction is Tc, and an average width of the side margin portion in the third direction is Wm, Wm is 18 μm or more and less than 200 μm, and Wm/Tc is 0.86 or more and 1.71 or less.

According to an aspect of the present disclosure, a multilayer electronic component includes a body including a capacitance forming portion in which a dielectric layer and an internal electrode overlap in a first direction; and an external electrode disposed on both surfaces of the body opposing each other in a second direction, perpendicular to the first direction, and connected to the internal electrode. The body includes a cover portion disposed on both surfaces of the capacitance forming portion, opposing each other in the first direction, and a side margin portion disposed on both surfaces of the capacitance forming portion, opposing each other in a third direction, perpendicular to the first and second directions. When an average thickness of the cover portion in the first direction is Tc and an average width of the side margin portion in the third direction is Wm, Wm/Tc is 1.47 or more and 1.71 or less.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 schematically illustrates a perspective view of a multilayer electronic component according to an embodiment;

FIG. 2 schematically illustrates a perspective view of a body according to an embodiment;

FIG. 3 schematically illustrates a cross-sectional view taken along line I-I′ of FIG. 1;

FIG. 4 schematically illustrates a cross-sectional view taken along line II-II′ of FIG. 1; and

FIGS. 5, 6, 7, 8, 9, and 10 schematically illustrate a method of manufacturing a multilayer electronic component according to an embodiment.

### DETAILED DESCRIPTION

Hereinafter, embodiments will be described with reference to detailed embodiments and the attached drawings. However, the embodiments may be modified in various other forms, and the scope of the present disclosure is not limited to the embodiments described below. Furthermore, the embodiments are provided to more fully explain the present disclosure to those skilled in the art. Therefore, the shapes and sizes of elements in the drawings may be exaggerated for clarity, and elements indicated by the same reference numerals in the drawings are identical elements.

In addition, to clearly describe the present disclosure, parts irrelevant to the description are omitted. The size and thickness of each component shown in the drawings are arbitrarily indicated for convenience of explanation. Therefore, the present disclosure is not necessarily limited to that shown. Furthermore, components with identical functions within the scope of the same concept are described using the same reference numerals. Furthermore, throughout the specification, when a part is referred to as “including” a component, this does not exclude other components, but rather implies the inclusion of other components, unless otherwise stated.

Also, in the drawing, the X-direction may refer to the thickness direction or the first direction, the Y-direction may refer to the length direction or the second direction, the Z-direction may refer to the width direction or the third direction, and the stacking direction of the internal electrode or dielectric layer may be the thickness direction or the width direction.

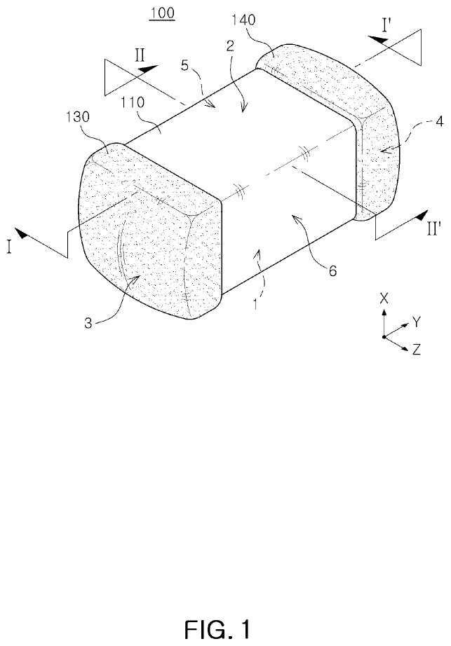

FIG. 1 schematically illustrates a perspective view of a multilayer electronic component according to an embodiment.

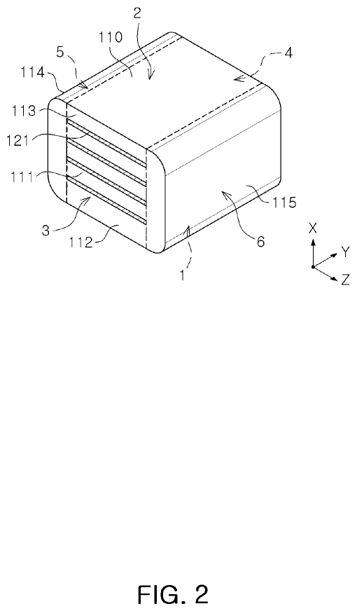

FIG. 2 schematically illustrates a perspective view of a body according to an embodiment.

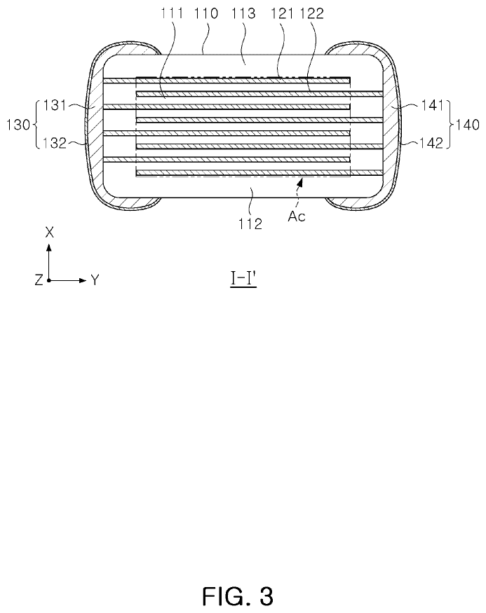

FIG. 3 schematically illustrates a cross-sectional view taken along line I-I′ of FIG. 1.

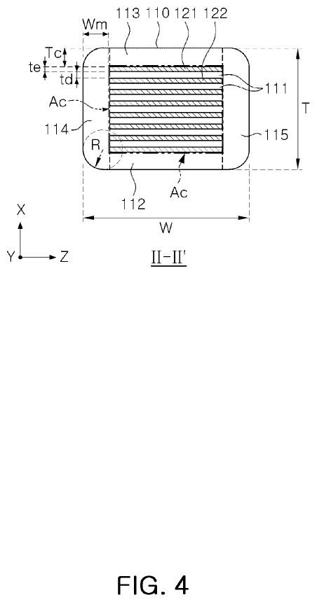

FIG. 4 schematically illustrates a cross-sectional view taken along line II-II′ of FIG. 1.

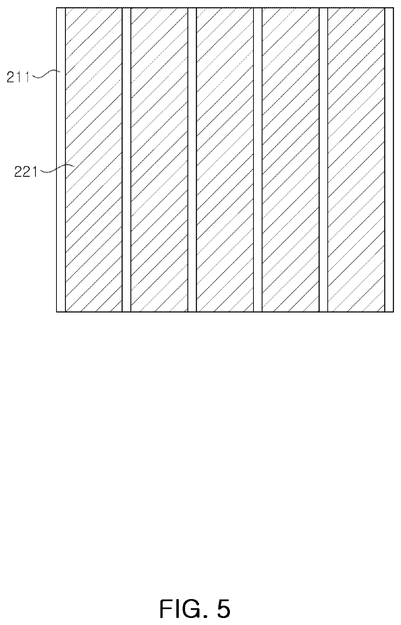

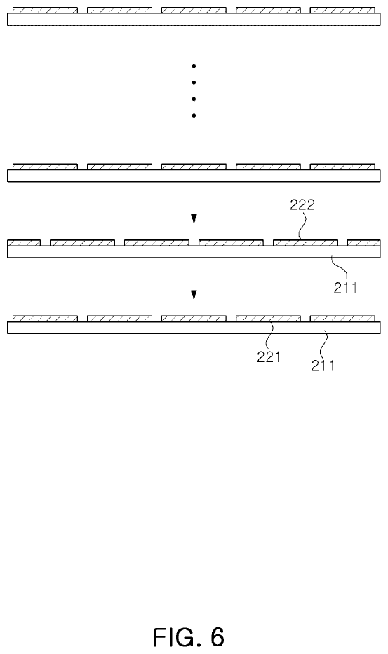

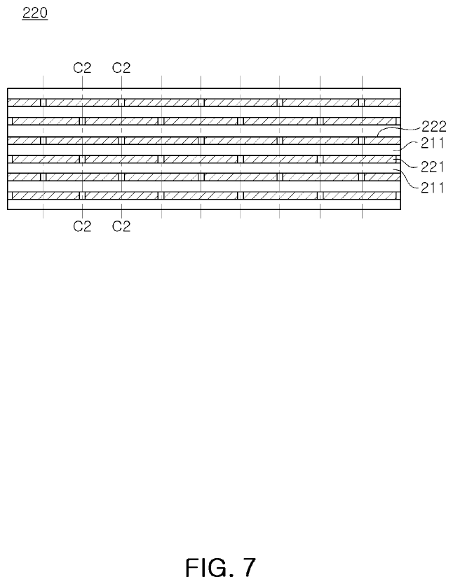

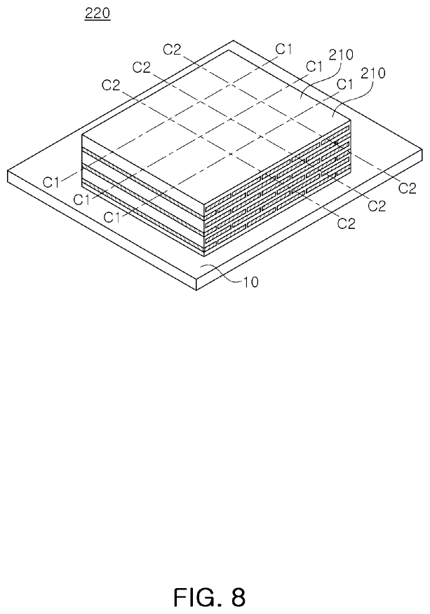

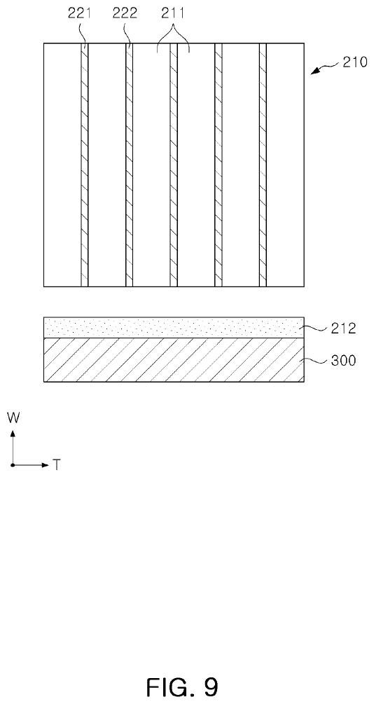

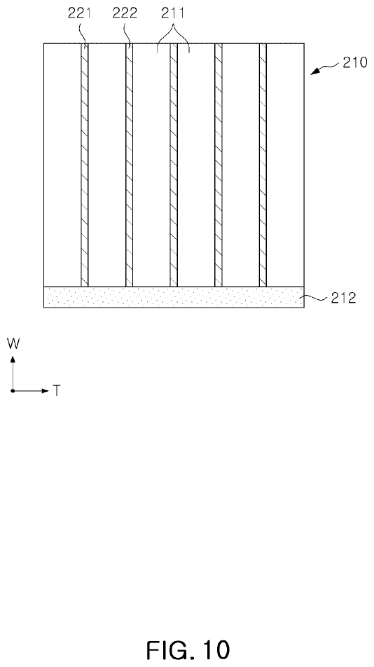

FIG. 5, FIG. 6, FIG. 7, FIG. 8, FIG. 9, and FIG. 10 schematically illustrate a method of manufacturing a multilayer electronic component according to an embodiment.

Hereinafter, with reference to FIG. 1, FIG. 2, FIG. 3 and FIG. 4, a multilayer electronic component 100 according to an embodiment and various embodiments thereof will be described.

The multilayer electronic component 100 according to an embodiment may include a body 110 including a capacitance forming portion Ac in which a dielectric layer 111 and internal electrodes 121 and 122 overlap in a first direction, and external electrodes 130 and 140 disposed on both surfaces of the body 110 opposing each other in a second direction perpendicular to the first direction and connected to the internal electrodes 121 and 122. The body 110 may include cover portions 112 and 113 disposed on both surfaces of the capacitance forming portion Ac opposing each other in the first direction, and side margin portions 114 and 115 disposed on both surfaces of the capacitance forming portion Ac opposing each other in a third direction perpendicular to the first and second directions.

Referring to FIG. 2 and FIG. 3, the body 110 may include a dielectric layer 111, and a first internal electrode 121 and a second internal electrode 122 that are alternately disposed with the dielectric layer 111 therebetween.

While there is no particular limitation on the detailed shape of the body 110, as illustrated, the body 110 may be formed in a hexahedral shape or a similar shape. Due to shrinkage of the ceramic powder contained in the body 110 during the firing process, the body 110 may not be a perfectly straight hexahedral shape, but may have a substantially hexahedral shape.

The body 110 may have first and second surfaces 1 and 2 opposing each other in a first direction, third and fourth surfaces 3 and 4 connected to the first and second surfaces 1 and 2 and opposing each other in a second direction, and fifth and sixth surfaces 5 and 6 connected to the first and second surfaces 1 and 2 and the third and fourth surfaces 3 and 4, and opposing each other in a third direction. In this case, the first direction may refer to the direction in which the first internal electrode 121 and the second internal electrode 122 are disposed with the dielectric layer 111 interposed therebetween, but the present disclosure is not limited thereto. For example, the direction in which the first internal electrode 121 and the second internal electrode 122 are disposed with the dielectric layer 111 interposed therebetween may be the second or third direction.

The raw material forming the dielectric layer 111 is not particularly limited as long as it may obtain sufficient electrostatic capacitance. For example, barium titanate-based materials, lead-composite perovskite-based materials, strontium titanate-based materials, or the like may be used. The barium titanate-based materials may include BaTiO₃-based ceramic powders. Examples of the ceramic powders may include BaTiO₃, or (Ba₁₋ₓCaₓ)TiO₃ (0<x<1), Ba(Ti_{1-y}Cay)O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), or the like, in which calcium (Ca), zirconium (Zr), or the like is partially dissolved in BaTiO₃.

Furthermore, the raw material for forming the dielectric layer 111 may be powder of barium titanate (BaTiO₃) or the like to which various ceramic additives, organic solvents, binders, dispersants, or the like may be added, depending on an embodiment of the present disclosure.

An average thickness td of the dielectric layer 111 does not need to be specifically limited. For example, if miniaturization and high-capacity of the multilayer electronic component 1000 are required, an average thickness td of the dielectric layer 111 may be 0.35 μm or less. If improved reliability of the multilayer electronic component 1000 under high temperature and high voltage is required, the average thickness td of the dielectric layer 111 may be 1 μm or more.

The average thickness td of the dielectric layer 111 may refer to the average thickness of one or more first dielectric layers among a plurality of first dielectric layers in the first direction.

The average thickness of the dielectric layer 111 in the first direction may be measured by scanning the cross-section of the multilayer electronic component 1000 in the first and second directions using a scanning electron microscope (SEM) at 10,000× magnification. In more detail, the first-direction average thickness of one dielectric layer 111 may refer to an average value calculated by measuring the first direction thicknesses at four or more equally spaced points of one dielectric layer 111 in the second direction in a scanned image. The four or more equally spaced points may be designated in the capacitance forming portion Ac. In addition, by extending this average value measurement to four or more dielectric layers 111 and measuring the average value, the first-direction average thickness of the dielectric layer 111 may be further generalized.

The internal electrodes 121 and 122 may be alternately disposed in the first direction with the dielectric layer 111, and may include the first internal electrode 121 connected to a first external electrode 130 and the second internal electrode 122 connected to a second external electrode 140.

The first and second internal electrodes 121 and 122 may be electrically isolated from each other by the dielectric layer 111 disposed therebetween.

The material forming the internal electrodes 121 and 122 is not particularly limited, and any material with excellent electrical conductivity may be used. For example, the internal electrodes 121 and 122 may include at least one of nickel (Ni), copper (Cu), palladium (Pd), silver (Ag), gold (Au), platinum (Pt), tin (Sn), tungsten (W), titanium (Ti), and alloys thereof.

Meanwhile, the thickness the of the internal electrodes 121 and 122 need not be specifically limited.

If miniaturization and high-capacity multilayer electronic components 1000 are required, the average thickness the of the internal electrodes 121 and 122 may be 0.35 μm or less. If the reliability of the multilayer electronic components 1000 is required to be improved under high temperature and high voltage, the average thickness the of the internal electrodes 121 and 122 may be 1 μm or more.

The average thickness the of the internal electrodes 121 and 122 may refer to the average thickness of one or more internal electrodes 121 and 122 in the first direction among a plurality of internal electrodes 121 and 122.

The first-direction average thickness of the internal electrodes 121 and 122 may be measured by scanning the cross-section of the multilayer electronic component 1000 in the first and second directions using a scanning electron microscope (SEM) at 10,000× magnification. In more detail, the first-direction average thickness of one internal electrode may be an average value calculated by measuring the first-direction thicknesses at four or more equally spaced points in the second direction of one internal electrode in the scanned image. The four or more equally spaced points may be designated in the capacitance forming portion Ac. Furthermore, by extending this average value measurement to four or more internal electrodes 121 and 122 and measuring the average value, the first-direction average thickness of the internal electrodes 121 and 122 may be further generalized.

Referring to FIG. 4, the body 110 may include the capacitance forming portion Ac, which is a region where a dielectric layer 111 and internal electrodes 121 and 122 overlap in a first direction. In detail, the capacitance forming portion Ac may be a region where the first internal electrode 121, the dielectric layer 111, and the second internal electrode 122 overlap in the first direction to form electrostatic capacitance.

Referring to FIGS. 2, 3, and 4, the cover portions 112 and 113 may be disposed on both surfaces of the capacitance forming portion Ac opposing each other in the first direction. The cover portions 112 and 113 do not include the internal electrodes 121 and 122 and may include the same dielectric material as the dielectric layer 111, but may have different compositions in detail.

Referring to FIGS. 2 and 4, side margin portions 114 and 115 may be disposed on both surfaces of the capacitance forming portion Ac opposing each other in the third direction.

As illustrated in FIG. 4, the side margin portions 114 and 115 may refer to the area between the boundary surface of the body 110 and both ends of the first and second internal electrodes 121 and 122 in a cross-section of the body 110 cut in the first and third directions.

The side margin portions 114 and 115 may fundamentally serve to prevent damage to the internal electrodes due to physical or chemical stress.

An example of a method of forming the side margin portions 114 and 115 will be described later.

According to an embodiment, when the first-direction average thickness of the cover portions 112 and 113 is Tc and the third-direction average width of the side margin portions 114 and 115 is Wm, Wm may be 18 μm or more and less than 200 μm, and Wm/Tc may be 0.86 or more and 1.71 or less.

In a multilayer electronic component in which when the third-direction average width of the side margin portions 114 and 115 is Wm, Wm is 18 μm or more and less than 200 μm, the ratio (Wm/Tc) of the third-direction average width Wm of the side margin portions 114 and 115 to the first-direction average thickness Tc of the cover portions 112 and 113 may have a significant impact on the chipping defect rate and moisture resistance reliability of the multilayer electronic component 100.

In detail, multilayer electronic components of the related art with a Wm value of less than 18 μm have a high incidence of chipping defects due to insufficient width of the side margin portion, and furthermore, may have reduced moisture resistance reliability due to a small penetration path of external moisture and plating solution.

Therefore, in a multilayer electronic component 100 according to an embodiment of the present disclosure, by ensuring that Wm is 18 μm or more and less than 200 μm, in more detail, 18 μm or more and 25 μm or less, chipping defects may be suppressed and the length of the penetration path of external moisture may be sufficiently increased, thereby reducing chipping defects and improving moisture resistance reliability of the multilayer electronic component 100.

However, in the case of a multilayer electronic component 100 with a Wm of 18 μm or more and less than 200 μm, the side margin portions 114 and 115 occupy a large proportion of the entire multilayer electronic component 100. Therefore, the corner area of the side margin portions 114 and 115 may increase compared to a multilayer electronic component of the related art. Consequently, there may be limitations in reducing the chipping defect and improving moisture resistance reliability of the multilayer electronic component 100.

In detail, in the multilayer electronic component 100 with a Wm of 18 μm or more and less than 200 μm, in the case in which the Wm/Tc is less than 0.86, the frequency of chipping defects increases and the moisture resistance reliability may deteriorate. On the other hand, when the Wm/Tc is 0.86 or more, the frequency of chipping defects may be significantly reduced and the moisture resistance reliability may also be improved.

Accordingly, in an embodiment of the present disclosure, in the multilayer electronic component 100 with a Wm of 18 μm or more and less than 200 μm, by adjusting the Wm/Tc to 0.86 or more, the proportion of the side margin portions 114 and 115 in the overall component may be appropriately adjusted, thereby significantly reducing the frequency of chipping defects and improving moisture resistance reliability of the multilayer electronic component 100.

Meanwhile, in the multilayer electronic component 100 with a Wm of 18 μm or more and less than 200 μm, the upper limit of Wm/Tc, which significantly reduces the frequency of chipping defects and improves moisture resistance reliability, is not particularly limited. The upper limit of Wm/Tc may be set at a level that secures an appropriate capacitance per unit volume of the multilayer electronic component 100. For example, Wm/Tc may be 1.71 or less.

Furthermore, according to an embodiment, the multilayer electronic component 100 may have a Wm/Tc of 1.47 or more and 1.71 or less, and in this case, the third-direction average width Wm of the side margin portions 114 and 115 is not particularly limited.

In detail, as in an embodiment, when Wm/Tc is 1.47 or more and 1.71 or less, the frequency of chipping defects in the multilayer electronic component 100 may be significantly reduced and the moisture resistance reliability may be significantly improved. Meanwhile, when Wm/Tc is 1.47 or more and 1.71 or less, the third-direction average width Wm of the side margin portions 114 and 115 need not be specifically limited.

The upper limit of Wm/Tc, which may significantly reduce the frequency of chipping defects and significantly improve moisture resistance reliability, is not specifically limited. The upper limit of Wm/Tc may be set at a level that ensures an appropriate capacitance per unit volume of the multilayer electronic component 100. For example, in an embodiment, Wm/Tc may be 1.71 or less.

The average thickness Tc of the cover portions 112 and 113 in the first direction may be measured by scanning the cross-section of the body 110 in the first and third directions using a scanning electron microscope (SEM) at 10,000× magnification. In detail, the average thickness Tc of the cover portions 112 and 113 in the first direction may refer to an average value calculated by measuring the first direction size at five or more equally spaced points in the third direction in a scanned image of one margin portion, but the present disclosure is not limited thereto.

The third-direction average width Wm of the side margin portions 114 and 115 may be measured by scanning the first and third-direction cross-section of the body 110 using a scanning electron microscope (SEM) at 10,000× magnification, and in more detail, may refer to an average value calculated by measuring the third-direction size at five or more equally spaced points in the first direction in a scanned image of one margin portion, but the present disclosure is not limited thereto.

In an embodiment, Wm/Tc may be 1.00 or more, 1.06 or more, 1.19 or more, 1.24 or more, or 1.47 or more. Accordingly, the chipping defect reduction effect and moisture resistance reliability improvement effect of the multilayer electronic component 100 according to an embodiment may be further enhanced.

In an embodiment, the first-direction average thickness Tc of the cover portions 112 and 113 may be 17 μm or more. Accordingly, the range of Wm/Tc according to an embodiment may be easily adjusted. The upper limit of the first-direction average thickness Tc of the cover portions 112 and 113 is not particularly limited. For example, the first-direction average thickness Tc of the cover portions 112 and 113 may be less than 200 μm, and in more detail, 21 μm or less.

Meanwhile, as in the multilayer electronic component 100 according to an embodiment, in the case in which the side margin portions 114 and 115 occupy a larger proportion of the entire component than multilayer electronic components of the related art, the area of the corner regions of the side margin portions 114 and 115, which are vulnerable to chipping defects and external moisture infiltration, also increases.

Meanwhile, when adjusting the ratio (Wm/R) of the average width Wm in the third direction of the side margin portions 114 and 115 to the average radius of curvature R of the corners of the side margin portions 114 and 115, the vulnerability of the corners of the side margin portions 114 and 115 may be compensated for by organically adjusting the average radius of curvature R of the corners of the side margin portions 114 and 115 and the average width Wm in the third direction of the side margin portions 114 and 115.

In detail, in an embodiment, when Wm/R is adjusted to 1.32 or less, the chipping defect reduction effect and moisture resistance reliability improvement effect of the multilayer electronic component 100 may be more significantly enhanced.

Meanwhile, there is no need to specifically limit the lower limit of Wm/R, and the lower limit of Wm/R may be adjusted depending on the processing process of the corners of the side margin portions 114 and 115. For example, Wm/R may be 0.47 or more.

The average radius of curvature R of the corners of the side margin portions 114 and 115 may be measured by scanning the cross-section of the body 110 in the first and third directions using a scanning electron microscope (SEM) at 10,000× magnification. In more detail, the average radius of curvature R of the corners of the side margin portions 114 and 115 may refer to the average value obtained by measuring the radii of curvature of respective corners in the images obtained by respectively scanning the four corners.

In an embodiment, a maximum thickness of the body 110 in the first direction may be 250 μm or less. Accordingly, a low-profile ceramic capacitor (LPCC) with a thin first-direction thickness of the multilayer electronic component 100 may be implemented. In this case, Wm may be 18 μm or more and 25 μm, or Tc may be 17 μm or more and 21 μm or less, but is not limited thereto.

In an embodiment, the body 110 may include an interface between the side margin portions 114 and 115 and the capacitance forming portion Ac. As in an embodiment, when an interface is formed between the side margin portions 114 and 115 and the capacitance forming portion Ac, a process of separately forming the side margin portions 114 and 115 on the capacitance forming portion Ac may be involved, so that the corners of the side margin portions 114 and 115 may be more vulnerable to chipping defects or external moisture penetration. However, according to an embodiment of the present disclosure, in a multilayer electronic component 100 where Wm is 18 μm or more and less than 200 μm, Wm/Tc is adjusted to 0.86 or more, or Wm/Tc is adjusted to 1.47 or more regardless of the Wm range. Therefore, even when an interface is formed between the side margin portions 114 and 115 and the capacitance forming portion Ac, an increase in the chipping defect rate or a decrease in the moisture resistance reliability of the multilayer electronic component 100 may be mitigated.

The interface between the side margin portions 114 and 115 and the capacitance forming portion Ac may be caused by differences in the composition or microstructure of the dielectric layer 111 of the capacitance forming portion Ac and the side margin portions 114 and 115.

In detail, in an embodiment, when the average porosity of the dielectric layer 111 is P0 and the average porosity of the side margin portions 114 and 115 is P1, the relationship P0<P1 may be satisfied. Depending on the porosity difference between the dielectric layer 111 and the side margin portions 114 and 115, an interface may be formed between the side margin portions 114 and 115 and the capacitance forming portion Ac.

Additionally, in an embodiment, the dielectric layer 111 and the side margin portions 114 and 115 may each include a plurality of dielectric grains. When the average size of the dielectric grains included in the dielectric layer 111 is G0 and the average size of the dielectric grains included in the side margin portions 114 and 115 is G1, G0<G1 may be satisfied. Depending on the difference in the average sizes of the dielectric grains included in the dielectric layer 111 and the side margin portions 114 and 115, an interface may be formed between the side margin portions 114 and 115 and the capacitance forming portion Ac.

In an embodiment, the side margin portions 114 and 115 may cover both side surfaces of the cover portions 112 and 113 opposing each other in the third direction. Accordingly, since the boundary between the cover portions 112 and 113 and the capacitance forming portion Ac, which is vulnerable to external moisture penetration, may be covered, the moisture resistance reliability of the multilayer electronic component 100 may be improved.

Referring to FIG. 1, the external electrodes 130 and 140 are disposed on the body 110.

In detail, the external electrodes 130 and 140 are disposed on the third surface 3 and the fourth surface 4, respectively, which are both surfaces of the body 110 opposing each other in the second direction, and may be connected to the internal electrodes 121 and 122.

The external electrodes 131 and 132 may be formed using any electrically conductive material, such as metal. The detailed material thereof may be determined based on electrical properties, structural stability, and other factors, and furthermore, the external electrodes may have a multilayer structure.

For example, the external electrodes 131 and 132 may include electrode layers 131 and 141 disposed on the body 110 and plating layers 132 and 142 disposed on the electrode layers 131 and 141.

In a more detailed example of the electrode layers 131 and 141, the electrode layers 131 and 141 may be sintered electrodes containing conductive metal and glass, or resin-based electrodes containing conductive metal and resin.

Furthermore, the electrode layers 131 and 141 may be formed by transferring a sheet containing a conductive metal onto the body 110, or may be formed by transferring a sheet containing a conductive metal onto a sintered electrode.

The conductive metal used in the electrode layers 131 and 141 is not particularly limited as long as it may be electrically connected to the internal electrodes 121 and 122 to form electrostatic capacitance. For example, the conductive metal may include at least one selected from the group consisting of nickel (Ni), copper (Cu), palladium (Pd), silver (Ag), gold (Au), platinum (Pt), tin (Sn), tungsten (W), titanium (Ti), and alloys thereof. The electrode layers 131 and 141 may be formed by applying a conductive paste prepared by adding glass frit to the conductive metal particles, and then firing the same.

The plating layers 132 and 142 may serve to improve mounting characteristics.

The type of plating layers 132 and 142 is not particularly limited, and may be the plating layers 132 and 142 which are each a single layer containing at least one of nickel (Ni), tin (Sn), silver (Ag), palladium (Pd), and alloys thereof, or may be formed of a plurality of layers.

For a more detailed example of the plating layers 132 and 142, the plating layers 132 and 142 may be a Ni plating layer or a Sn plating layer, and may be in a form in which a Ni plating layer and a Sn plating layer are sequentially formed on the electrode layers 131 and 141, or may be in a form in which a Sn plating layer, a Ni plating layer, and a Sn plating layer are sequentially formed. In addition, the plating layers 132 and 142 may include a plurality of Ni plating layers and/or a plurality of Sn plating layers.

Hereinafter, a method of manufacturing a multilayer electronic component 100 according to an embodiment will be described. However, the present disclosure is not intended to be limited to the multilayer electronic component 100 manufactured using the manufacturing method described below.

As illustrated in FIG. 5, a plurality of stripe-shaped first internal electrode patterns 221 are formed at predetermined intervals on a ceramic green sheet 211. The plurality of stripe-shaped first internal electrode patterns 221 may be formed parallel to one another.

Also, although not illustrated, a plurality of stripe-shaped second internal electrode patterns 222 may be formed at predetermined intervals on another ceramic green sheet 211.

Hereinafter, the ceramic green sheet on which the first internal electrode pattern 221 is formed may be referred to as a first ceramic green sheet, and the ceramic green sheet on which the second internal electrode pattern 222 is formed may be referred to as a second ceramic green sheet.

Next, as illustrated in FIG. 6, the first and second ceramic green sheets may be alternately stacked so that the stripe-shaped first internal electrode pattern 221 and the stripe-shaped second internal electrode pattern 222 are alternately stacked.

Thereafter, the stripe-shaped first internal electrode pattern 221 may become the first internal electrode 121, and the stripe-shaped second internal electrode pattern 222 may become the second internal electrode 122.

FIG. 7 is a cross-sectional view illustrating a ceramic green sheet laminated body 220 in which the first and second ceramic green sheets are laminated, and FIG. 8 is a perspective view illustrating a ceramic green sheet laminated body 220 in which the first and second ceramic green sheets are laminated.

A first ceramic green sheet printed with a plurality of parallel stripe-shaped first internal electrode patterns 221 and a second ceramic green sheet printed with a plurality of parallel stripe-shaped second internal electrode patterns 222 are alternately laminated.

Although not shown in the drawings, a cover sheet that may be formed as cover portions 112 and 113 according to an embodiment may be disposed on the upper and lower surfaces of the laminated body 220. By varying the thickness of the cover sheet or the degree of lamination of the sheets, the average thickness of the cover portions 112 and 113 in the first direction may be adjusted.

Next, as illustrated in FIG. 8, the ceramic green sheet laminated body 220 may be cut to cross the plurality of stripe-shaped first internal electrode patterns 221 and stripe-shaped second internal electrode patterns 222. For example, the ceramic green sheet laminated body 220 may become laminated bars 210 by cutting along the orthogonal cutting lines C1-C1 and C2-C2.

For example, the bar-shaped laminate may be cut such that a predetermined gap formed between the center of the overlapping first internal electrode and the second internal electrode is cut along the same cutting line. Accordingly, one end of the first and second internal electrodes may be alternately exposed on the cut surface.

Thereafter, a side margin sheet may be formed on first and second side surfaces of the laminated bar 210.

Next, as illustrated in FIGS. 9 and 10, a first side margin sheet 212 may be formed on the first side surface of the laminated bar 210. The first side margin sheet 212 may be formed by punching using an elastic material 300. Subsequently, by rotating the laminated bar 210, a second side margin sheet may be formed on the second side surface of the laminated bar 210.

Next, the laminated body, in which the first and second side margin sheets are formed on both side surfaces of the laminated bar 210, may be plasticized and fired to form a body including a dielectric layer and first and second internal electrodes 121 and 122. After this process, the first and second side margin sheets may form side margin portions 114 and 115 according to an embodiment.

At this time, by adjusting the thickness of the first and second side margin sheets or the number of sheets stacked, the average width Wm of the side margin portions 114 and 115 in the third direction according to an embodiment may be adjusted.

Next, a process of polishing the corners of the side margin portions 114 and 115 may be performed. By adjusting variables such as polishing pressure and polishing time during the polishing process, the average radius of curvature R of the side margin portions 114 and 115 according to an embodiment may be adjusted.

Thereafter, external electrodes 130 and 140 may be formed on the third surface 3 of the body 110 where the first internal electrode 121 is exposed, and on the fourth surface 4 of the body 110 where the second internal electrode 122 is exposed, respectively.

### Experimental Example

Tables 1 and 2 below show the chipping frequency and moisture resistance reliability evaluation results for multilayer electronic component samples with varying a cover portion average thickness Tc in the first direction, a side margin portion average width Wm in the third direction, and an average radius of curvature R of corners of side margin portions.

Respective samples were manufactured using the same method described above for manufacturing multilayer electronic components, except that the thickness and number of layers of the cover sheet, the thickness and number of layers of the side margin sheet, and the polishing pressure and time of the side margin portion were adjusted accordingly.

Meanwhile, the frequency of chipping occurrence was measured by mounting a sample and observing whether chipping or breakage occurred at the corner of the side margin using an optical microscope. If chipping or breakage occurred at least once per sample, the sample was determined to be defective.

For the moisture resistance reliability evaluation, a failure was determined when the insulation resistance value dropped to 10502 or less under the following conditions.

(Moisture Resistance Reliability Evaluation Conditions): Temperature: 85° C., Relative humidity: 85%, Applied voltage: 1 to 1.5 Vr, Applied voltage duration: 8 hours or more

TABLE 1

| | | | | | Moisture | |
|---|---|---|---|---|---|---|
| | | | | | Resistance | |
| | | | | | Reliability | |
| | | | | Chipping | Evaluation | |
| | | | | Occurrence | (Number of | Defect |
| Class- | Tc | Wm | Wm/ | Frequency | Defects/ | Rate |
| ification | (μm) | (μm) | Tc | (ppm) | Samples) | (ppm) |
| Com- | 17 | 14 | 0.82 | 2000 or more | 8/1200 | 6667 |
| parative | | | | | | |
| Example 1 | | | | | | |
| Example 1 | 17 | 18 | 1.06 | 1000 or less | 5/1200 | 3333 |
| Example 2 | 17 | 21 | 1.24 | 750 or less | 2/1200 | 1667 |
| Example 3 | 17 | 25 | 1.47 | 500 or less | 1/1200 | 833 |
| Com- | 21 | 14 | 0.67 | 2000 or more | 6/1200 | 5000 |
| parative | | | | | | |
| Example 2 | | | | | | |
| Example 4 | 21 | 18 | 0.86 | 1000 or less | 4/1200 | 3333 |
| Example 5 | 21 | 21 | 1.00 | 750 or less | 2/1200 | 833 |
| Example 6 | 21 | 25 | 1.19 | 500 or less | 1/1200 | 833 |

Referring to Table 1, Comparative Example 1, where the Wm/Tc is less than 0.86, exhibits a chipping frequency of 2,000 ppm or more and deterioration in moisture resistance reliability.

Conversely, Examples 5, 6, and 7, where the Wm/Tc is 0.86 or more, exhibit a significant improvement in chipping frequency from 2,000 ppm or more to 1,000 ppm or less, demonstrating improved moisture resistance reliability.

Meanwhile, in the case of Example 3 where the Wm/Tc is 1.47, it can be confirmed that a chipping frequency is 500 ppm or less and the number of moisture resistance reliability defects is 1/1,200, thereby demonstrating significant improvements in both chipping defect and moisture resistance reliability.

TABLE 2

| | | | | | Moisture | |
|---|---|---|---|---|---|---|
| | | | | | Resistance | |
| | | | | | Reliability | |
| | | | | Chipping | Evaluation | |
| | | | | Occurrence | (Number of | Defect |
| Class- | Wm | | Wm/ | Frequency | Defects/ | Rate |
| ification | (μm) | R | R | (ppm) | Samples) | (ppm) |
| Com- | 18 | 13.5 | 1.33 | 2000 or more | 5/1200 | 4167 |
| parative | | | | | | |
| Example 3 | | | | | | |
| Example 7 | 18 | 19 | 0.95 | 1000 or less | 4/1200 | 3333 |
| Example 8 | 18 | 23 | 0.78 | 850 or less | 3/1200 | 2500 |
| Example 9 | 18 | 26 | 0.70 | 850 or less | 1/1200 | 1667 |
| Example 10 | 21 | 19 | 1.11 | 1000 or less | 4/1200 | 3333 |
| Example 11 | 21 | 23 | 0.91 | 850 or less | 3/1200 | 2500 |
| Example 12 | 21 | 26 | 0.81 | 650 or less | 1/1200 | 1667 |
| Example 13 | 25 | 19 | 1.32 | 1000 or less | 4/1200 | 3333 |
| Example 14 | 25 | 23 | 1.09 | 700 or less | 3/1200 | 2500 |

Referring to Table 2, for Comparative Example 3, where Wm/R exceeds 1.32, the chipping frequency is 2000 ppm or more, and moisture resistance reliability is deteriorated.

On the other hand, for Examples 7 to 14, where Wm/R is 1.32 or less, the chipping frequency is 1000 ppm or less, and the moisture resistance reliability defect number is 4/1200 or less, confirming that chipping defects and moisture resistance reliability are improved.

As set forth above, according to an embodiment, a phenomenon of chipping defects occurring at corners of a side margin portion may be alleviated.

According to an embodiment, moisture resistance reliability of multilayer electronic components may be improved.

According to an embodiment, chipping defects of a multilayer electronic component having a low-profile ceramic capacitor structure may be alleviated and moisture resistance reliability thereof may be improved.

While embodiments have been described in detail above, the present disclosure is not limited to the above-described embodiments and the attached drawings, but is intended to be defined by the appended claims. Therefore, those skilled in the art will appreciate that various substitutions, modifications, and alterations may be made without departing from the technical spirit of the present disclosure as defined in the claims, and such modifications are also within the scope of the present disclosure.

Furthermore, the term “an embodiment” used herein does not imply identical embodiments, and rather, is provided to emphasize and explain the unique features of each embodiment. However, the presented embodiments do not preclude implementation in combination with features of other embodiments. For example, even if a description in a specific embodiment is not described in another embodiment, it can be understood as relating to the other embodiment, unless otherwise described in the other embodiment, which is contrary to or contradicts the description.

The terminology used in this disclosure is solely for describing an embodiment and is not intended to limit the present disclosure. In this case, singular expressions include plural expressions unless the context clearly indicates otherwise.

While example embodiments have been shown and described above, it will be apparent to those skilled in the art that modifications and variations could be made without departing from the scope of the present disclosure as defined by the appended claims.

What is claimed is:

1. A multilayer electronic component comprising:
a body including a capacitance forming portion in which a dielectric layer and an internal electrode overlap in a first direction; and
an external electrode disposed on both surfaces of the body opposing each other in a second direction, perpendicular to the first direction, and connected to the internal electrode,
wherein the body includes a cover portion disposed on both surfaces of the capacitance forming portion, opposing each other in the first direction, and a side margin portion disposed on both surfaces of the capacitance forming portion, opposing each other in a third direction, perpendicular to the first and second directions, and
wherein, when an average thickness of the cover portion in the first direction is Tc, and an average width of the side margin portion in the third direction is Wm, Wm is 18 μm or more and less than 200 μm, and Wm/Tc is 0.86 or more and 1.71 or less.

2. The multilayer electronic component of claim 1, wherein Wm/Tc is 1.47 or more and 1.71 or less.

3. The multilayer electronic component of claim 1, wherein Tc is 17 μm or more.

4. The multilayer electronic component of claim 1, wherein, when an average radius of curvature of corners of the side margin portion is R, Wm/R is 1.32 or less.

5. The multilayer electronic component of claim 1, wherein Wm is 18 μm or more and 25 μm or less, and
a maximum thickness of the body in the first direction is 250 μm or less.

6. The multilayer electronic component of claim 1, wherein the body includes an interface between the capacitance forming portion and the side margin portion.

7. The multilayer electronic component of claim 1, wherein, when an average porosity of the dielectric layer is P0 and an average porosity of the side margin portion is P1, P0<P1 is satisfied.

8. The multilayer electronic component of claim 1, wherein, when an average size of dielectric grains included in the dielectric layer is G0 and an average size of dielectric grains included in the side margin portion is G1, G0<G1 is satisfied.

9. A multilayer electronic component comprising:
a body including a capacitance forming portion in which a dielectric layer and an internal electrode overlap in a first direction; and
an external electrode disposed on both surfaces of the body opposing each other in a second direction, perpendicular to the first direction, and connected to the internal electrode,
wherein the body includes a cover portion disposed on both surfaces of the capacitance forming portion, opposing each other in the first direction, and a side margin portion disposed on both surfaces of the capacitance forming portion, opposing each other in a third direction, perpendicular to the first and second directions, and
when an average thickness of the cover portion in the first direction is Tc and an average width of the side margin portion in the third direction is Wm, Wm/Tc is 1.47 or more and 1.71 or less.

10. The multilayer electronic component of claim 9, wherein Tc is 17 μm or more.

11. The multilayer electronic component of claim 9, wherein, when an average radius of curvature of corners of the side margin portion is R, Wm/R is 1.32 or less.

12. The multilayer electronic component of claim 9, wherein Wm is 18 μm or more and 25 μm or less, and
a maximum thickness of the body in the first direction is 250 μm or less.

13. The multilayer electronic component of claim 9, wherein the body includes an interface between the capacitance forming portion and the side margin portion.

14. The multilayer electronic component of claim 9, wherein, when an average porosity of the dielectric layer is P0 and an average porosity of the side margin portion is P1, P0<P1 is satisfied.

15. The multilayer electronic component of claim 9, wherein, when an average size of dielectric grains included in the dielectric layer is G0 and an average size of dielectric grains included in the side margin portion is G1, G0<G1 is satisfied.
